(19) United States
(12) Patent Application Publication
(10) Pub. No.: US 2026/0040350 A1
(43) Pub. Date: Feb. 5, 2026

(54) UE ASSISTANCE INFORMATION FOR MEASUREMENT GAP DEACTIVATION

(71) Applicant: QUALCOMM Incorporated, San Diego, CA (US)

(72) Inventors: Prashant SHARMA, San Marcos, CA (US); Diana MAAMARI, San Diego, CA (US); Huilin XU, Temecula, CA (US); Jae Ho RYU, San Diego, CA (US)

(21) Appl. No.: 18/790,724

(22) Filed: Jul. 31, 2024

(51) Int. Cl. H04W 74/0808; H04W 24/08

(52) U.S. Cl. CPC H04W 74/0808; H04W 24/08

(57) ABSTRACT

Methods, systems, and devices for wireless communications are described. A user equipment (UE) transmits an indication of one or more types of measurement gaps for which deactivation is supported based on collisions with data having a priority satisfying a threshold. The UE receives an indication of deactivation of one or more measurement gaps based on the indication of one or more types of measurement gaps. The UE receives the data during a time duration that at least partially overlaps with the one or more measurement gaps based on the indication of deactivation.

### FIELD OF TECHNOLOGY

The following relates to wireless communications, including measurement gap deactivation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications, the UE may communicate with a network entity via a serving cell. The UE may be configured with a measurement gap, during which the UE may not transmit uplink signals or receive downlink signals. Since there is no signal transmission and reception during the measurement gap, the UE may perform signal quality measurements on the serving cell as well as target cells (e.g., neighboring cells). However, measurement gaps may present challenges for some types of communication.

### SUMMARY

The systems, methods, and devices of this disclosure each have several innovative aspects, no single one of which is solely responsible for the desirable attributes disclosed herein. A method for wireless communications by a user equipment (UE) is described. The method may include transmitting an indication of one or more types of measurement gaps for which deactivation is supported based on collisions with data having a priority satisfying a threshold, receiving an indication of deactivation of one or more measurement gaps based on the indication of one or more types of measurement gaps, and receiving the data during a time duration that at least partially overlaps with the one or more measurement gaps based on the indication of deactivation.

A UE for wireless communications is described. The UE may include one or more memories storing processor executable code, and one or more processors coupled with the one or more memories. The one or more processors may individually or collectively be operable to execute the code to cause the UE to transmit an indication of one or more types of measurement gaps for which deactivation is supported based on collisions with data having a priority satisfying a threshold, receive an indication of deactivation of one or more measurement gaps based on the indication of one or more types of measurement gaps, and receive the data during a time duration that at least partially overlaps with the one or more measurement gaps based on the indication of deactivation.

Another UE for wireless communications is described. The UE may include means for transmitting an indication of one or more types of measurement gaps for which deactivation is supported based on collisions with data having a priority satisfying a threshold, means for receiving an indication of deactivation of one or more measurement gaps based on the indication of one or more types of measurement gaps, and means for receiving the data during a time duration that at least partially overlaps with the one or more measurement gaps based on the indication of deactivation.

A non-transitory computer-readable medium storing code for wireless communications is described. The code may include instructions executable by one or more processors to transmit an indication of one or more types of measurement gaps for which deactivation is supported based on collisions with data having a priority satisfying a threshold, receive an indication of deactivation of one or more measurement gaps based on the indication of one or more types of measurement gaps, and receive the data during a time duration that at least partially overlaps with the one or more measurement gaps based on the indication of deactivation.

In some examples of the method, UEs, and non-transitory computer-readable medium described herein, the indication includes a bitmap indicating the one or more types of measurement gaps via bits of the bitmap.

In some examples of the method, UEs, and non-transitory computer-readable medium described herein, the data having the priority satisfying the threshold includes extended reality data.

Some examples of the method, UEs, and non-transitory computer-readable medium described herein may further include operations, features, means, or instructions for receiving the data based on suppressing the one or more types of measurement gaps.

In some examples of the method, UEs, and non-transitory computer-readable medium described herein, the one or more types of measurement gaps include one or more of a UE-specific measurement gap, a frequency range specific measurement gap, a preconfigured measurement gap, a network controlled small gap, an uplink measurement gap, a multi-(U)SIM measurement gap, and a transmit power management measurement gap.

In some examples of the method, UEs, and non-transitory computer-readable medium described herein, transmitting the indication may include operations, features, means, or instructions for transmitting, periodically, the indication of the one or more types of measurement gaps.

In some examples of the method, UEs, and non-transitory computer-readable medium described herein, transmitting the indication may include operations, features, means, or instructions for transmitting, based on a trigger event, the indication of the one or more types of measurement gaps.

Some examples of the method, UEs, and non-transitory computer-readable medium described herein may further include operations, features, means, or instructions for transmitting the indication may be based on UE assistance information.

In some examples of the method, UEs, and non-transitory computer-readable medium described herein, transmitting may include operations, features, means, or instructions for transmitting a subset of the UE assistance information for the one or more types of measurement gaps.

Some examples of the method, UEs, and non-transitory computer-readable medium described herein may further include operations, features, means, or instructions for transmitting a second indication of a second one or more types of measurement gaps associated with a change since the indication of the one or more types of measurement gaps.

Some examples of the method, UEs, and non-transitory computer-readable medium described herein may further include operations, features, means, or instructions for receiving the indication of deactivation includes a downlink control information signal, a medium access control element signal, a radio resource control signal, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports measurement gap deactivation in accordance with one or more aspects of the present disclosure.

FIG. 2 shows an example of a wireless communications system that supports measurement gap deactivation in accordance with one or more aspects of the present disclosure.

FIG. 3 shows an example of a timing diagram that supports measurement gap deactivation in accordance with one or more aspects of the present disclosure.

FIG. 4 shows an example of a process flow that supports measurement gap deactivation in accordance with one or more aspects of the present disclosure.

FIGS. 5 and 6 show block diagrams of devices that support measurement gap deactivation in accordance with one or more aspects of the present disclosure.

FIG. 7 shows a block diagram of a communications manager that supports measurement gap deactivation in accordance with one or more aspects of the present disclosure.

FIG. 8 shows a diagram of a system including a device that supports measurement gap deactivation in accordance with one or more aspects of the present disclosure.

FIGS. 9 and 10 show flowcharts illustrating methods that support measurement gap deactivation in accordance with one or more aspects of the present disclosure.

### DETAILED DESCRIPTION

In some wireless communications, a user equipment (UE) may communicate with a network entity via a serving cell. The UE may be configured with a measurement gap configuration causing the UE to not transmit uplink signals or receive downlink signals during a measurement gap. Instead of signal transmission and reception with the serving cell during the measurement gap, the UE may perform signal quality measurements on the serving cell as well as target cells (e.g., neighboring cells).

In some examples, the serving cell may communicate high priority data (e.g., data having a priority greater than a priority threshold) to the UE. The high priority data may include data that is time-critical, such as extended reality (XR) data. However, a measurement gap may be scheduled for the UE to perform measurements while the UE is to receive the high priority data.

As discussed herein, the UE may provide UE assistance information (UAI) to the network entity that indicates which types of measurement gaps may be deactivated if the measurement gaps collide with the time-critical data. The UAI may be transmitted periodically or based on a trigger, such as a network entity trigger (e.g., a network indication to send the UAI when the time-critical data is expected at the UE) or an event trigger (e.g., change in UE mobility). In some examples, the network entity may indicate to the UE to transmit particular components of the UAI, such as components that may not otherwise be deduced from measurement reports. In some examples, the UE may send the entire UAI or particular components of the UAI, such as components that have changed since the last UAI indication to the network entity 105. The UAI indicating which types of measurement gaps may be deactivated (e.g., or skipped) may reduce collisions between measurement gaps and data to be received at the UE 115.

Aspects of the disclosure are initially described in the context of wireless communications systems. Aspects of the disclosure are further illustrated by and described with reference to apparatus diagrams, system diagrams, and flowcharts that relate to measurement gap deactivation.

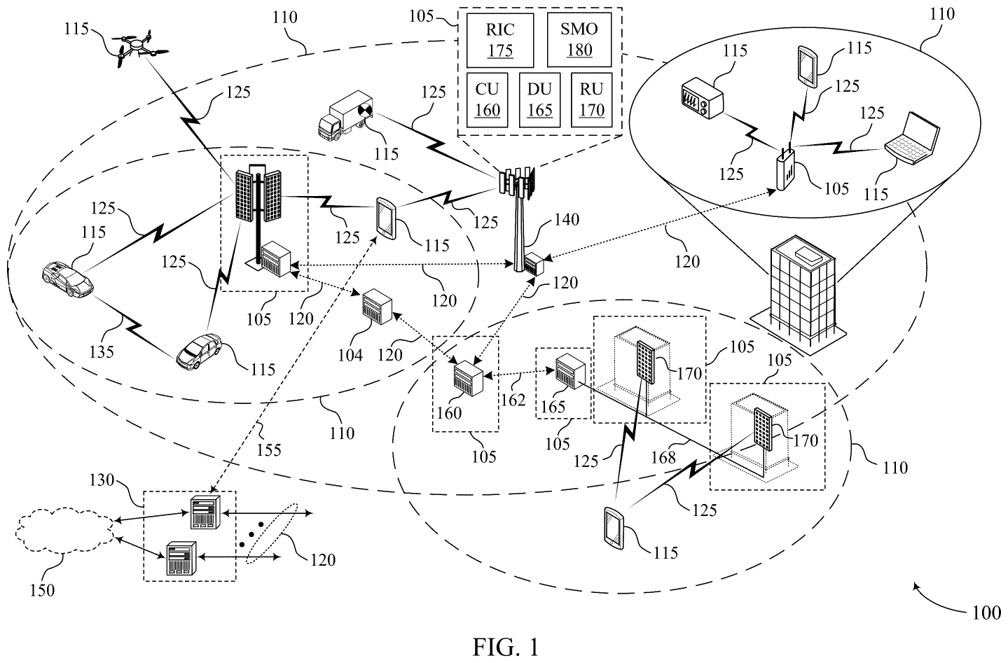

FIG. 1 shows an example of a wireless communications system 100 that supports measurement gap deactivation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless

communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an Fl interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications, the UE 115 may communicate with the network entity 105 via a serving cell. The UE 115 may be configured with a measurement gap configuration causing the UE 115 to not transmit uplink signals or receive downlink signals with the serving cell during a measurement gap. Instead of signal transmission and reception with the serving cell during the measurement gap, the UE 115 may perform signal quality measurements on the serving cell and/or target cells (e.g., neighboring cells).

In some examples, the serving cell may communicate high priority data (e.g., data having a priority greater than a priority threshold) to the UE 115. The high priority data may include data that is time-critical, such as extended reality (XR) data. However, a measurement gap may be scheduled for the UE 115 to perform measurements while the UE 115 is to receive the high priority data.

As discussed herein, the UE 115 may provide UAI to the network entity 105 that indicates which types of measurement gaps may be deactivated if the measurement gaps collide with the time-critical data. The UAI may be transmitted periodically or based on a trigger, such as a network entity trigger (e.g., network indication to send the UAI when the time-critical data is expected at the UE 115) or an event trigger (e.g., change in UE 115 mobility). In some examples, the network entity 105 may indicate to the UE 115 to transmit particular components of the UAI, such as components that may not otherwise be deduced from measurement reports. In some examples, the UE 115 may send the entire UAI or particular components of the UAI, such as components that have changed since the last UAI indication to the network entity 105. The UAI indicating which types of measurement gaps may be deactivated (e.g., or skipped) may reduce collisions between measurement gaps and data to be received at the UE 115.

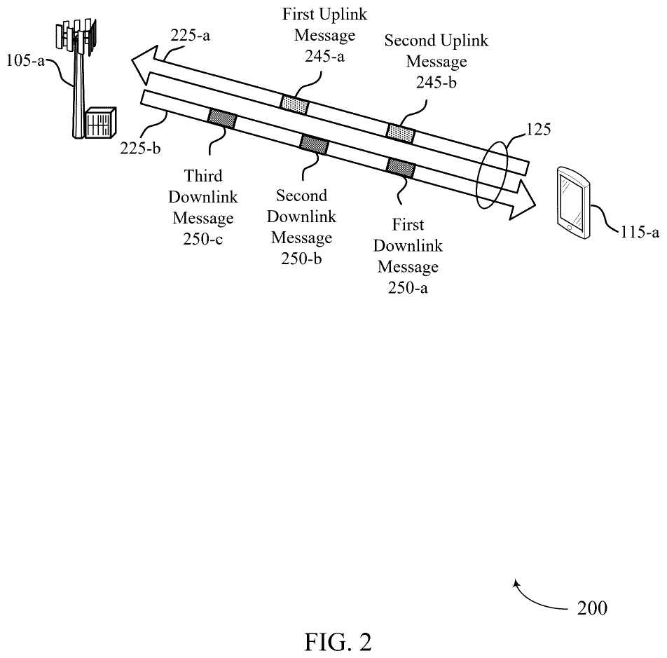

FIG. 2 shows an example of a wireless communications system 200 that supports measurement gap deactivation in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1.

In some examples, when the UE 115-a is mobile within the serving cell, the mobility may cause a trigger event to occur (e.g., UE 115-a may report events such as an Event A3 to the network entity 105-a). Based on one or more trigger events, the network entity 105-a may configure the UE 115-a to perform measurements on candidate neighbor cells. In some cases, the neighbor cells may communicate on different frequencies and the UE 115-a may perform measurements to determine if the neighbor cells may provide better signal quality on the different frequencies than the serving cell. The network may configure measurement gaps for performing measurements on the neighbor cells.

During a measurement gap, the UE 115-a may tune from the serving cell frequency to a target frequency associated with a neighboring cell. The UE 115-a may not send data or receive data with the serving cell during the measurement gap. The measurement gap may result in delays for data transfer, including delay-critical traffic.

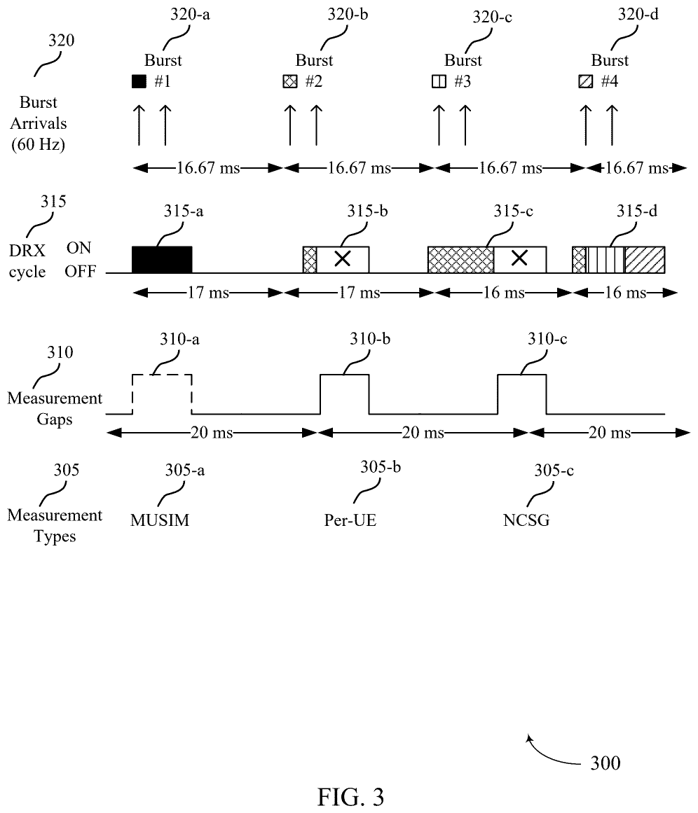

In some examples, the delay-critical data, such as XR data, may be more likely to overlap with the measurement gaps or other data traffic. As discussed in more detail in FIG. 3, a mismatch may occur between an integer periodicity associated with the measurement gap and an integer periodicity associated with the XR data.

In particular, a discontinuous reception (DRX) timer cycle may indicate the interval between consecutive wake-up periods. For example, the DRX timer may indicate one or more on-duration cycles (e.g., active periods) and one or more off-duration cycles (e.g., sleep periods), where the UE 115-a monitors control channels (e.g., physical downlink control channel (PDCCH)) for incoming data during the on-duration cycle. When a DRX timer expires in middle of the measurement gap, then the remaining XR data reception may be deferred to the subsequent DRX cycle (e.g., XR data reception is paused and subsequently received during the next on-duration cycle).

In some examples, measurements may be triggered or enabled by network entity 105-a signaling, which may also restrict transmitting or receiving data during the measurement gaps. In some examples, the signaling from the network entity 105-a may include a dynamic indication to enable transmission or reception of data in particular measurement gaps caused by radio resource management (RRM) measurements. The dynamic indication to enable the transmission or reception may involve the network entity 105-a communicating an explicit indication via downlink control information (DCI) to the UE 115-a, indicating to skip a particular measurement gap. The indication may be provided as part of scheduling information. In some examples, the indication may be provided in a bit-field of the DCI having a size that is a single bit or greater than a single bit. The indication may also provide a minimum time offset between the end of the first dynamic indication and the start of the measurement gap indicated to be skipped.

In some examples, the dynamic indication to enable the transmission or reception may involve the network entity 105-a communicating an explicit indication by the DCI that indicates a time window in which to skip one or more measurement gaps. In such examples, the indication may provide a minimum time offset between the end of the dynamic indication and start of measurement gap indicated to be skipped in the time window.

In some examples, the dynamic indication to enable the transmission or reception may involve the network entity 105-a communicating an implicit indication by the DCI that schedules transmission and reception that overlap with the measurements. The indication may indicate skipping the overlapped measurement gaps. In such examples, the indication may provide a minimum time offset between the end of received dynamic indication and start of the measurement gap occasion to be skipped.

In some examples, the dynamic indication to enable the transmission or reception at the UE 115-a may be in the form of a DCI format with DCI content, and having a DCI bit-field size. The dynamic indication may indicate whether the indication is for one or more occasions of measurement gaps. In some examples, the indication to enable the transmission and reception may also consider a time offset between the end of a received dynamic indication and a start of the measurement gap occasion to be skipped.

In some examples, the network entity 105-a signaling that enables transmitting or receiving data during the measurement gaps may involve a semi-static solution to enable the transmission or reception during the measurement gaps. For example, the network entity 105-a may configure the UE 115-a with a measurement gap skipping pattern via RRC, indicating a pattern of which measurement gaps to skip. In some examples, the pattern may be based on periodicity, offset, and duration. The pattern may be based on a bitmap. The pattern may also indicate whether the pattern is to be applied to all measurement gaps or a subset of the measurement gap occasions.

In some examples, the semi-static solution may include the network entity 105-a configuring the UE 115-a to skip a measurement gap that collides with transmission or reception occasions that have semi-statically configured. In some examples, the semi-static solution may include the network entity 105-a configuring the UE 115-a to skip a measurement gap based on priority information associated with the transmission or reception occasion and/or priority information associated with the particular monitoring occasion. For example, if the transmission or reception has a greater priority (e.g., based on the data communication in the occasion), then the lower priority measurement gap may be skipped. The priorities may be semi-statically configured by the network entity 105-a.

In some examples, UAI related to measurement occasions may be used for skipping measurement gaps that collide with transmission or reception occasions. The UAI information related to measurement occasions may include a quantity of measurement gaps and/or synchronization signal (SS)/Physical Broadcast Channel (PBCH) block measurement timing configuration (SMTC) gaps to be used within a period, a maximum quantity or ratio of measurement gaps to SMTC that may be skipped within a period, a quantity of SSBs to be used within a time period, a quantity of consecutive measurement gaps for RRM measurements that may be skipped, the maximum interval between two consecutively reserved measurement gap occasions for the RRM measurements, and/or patterns of measurement gaps where skipping may be allowed.

In some examples, the UAI may include assistance information related to channel conditions. For example, the UAI may include a reference signal received power (RSRP) that is great than or less than a threshold (e.g., ssb-RSRP or channel state information (CSI) RSRP, s-MeasureConfig). In some examples, the UAI may include assistance information related to traffic. For example, the UAI may include information related to packet data unit (PDU) sets, such as PDU set importance.

In some examples, the UAI may include assistance information related to UE mobility. For example, the UAI may include layer 3 (L3) parameters related to mobility, such as whether the UE is static or mobile.

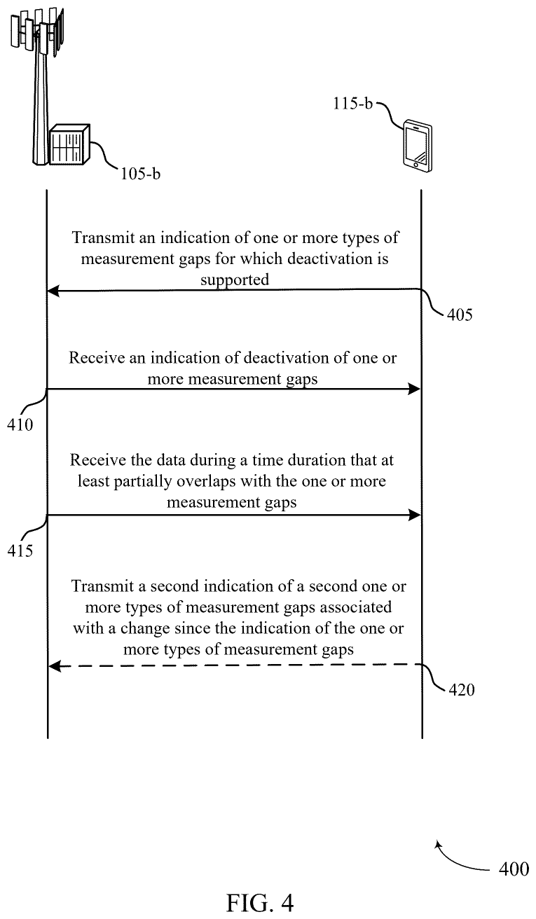

In some examples, UAI related to measurement gap occasions may be used for skipping measurement gaps that collide with transmission or reception occasions that carry time-critical data, such as XR data. The network entity 105-a may indicate the measurement gap skipping or deactivation dynamically via DCI signaling, semi-persistently via medium access control (MAC) control element (CE) (MAC-CE) signaling, semi-statically via RRC signaling, or a combination thereof. Some UAI transmission triggering mechanisms are discussed herein, for example, as discussed with respect to FIG. 3 and FIG. 4.

In the wireless communications system 200, the network entity 105-a may communicate with the UE 115-a using a communication link 125. In some examples, the communication link 125 may include a first channel 225-a for transmitting data from the UE 115-a to the network entity 105-a and a second channel 225-b for transmitting data from the network entity 105-a to the UE 115-a. The communication link 125 may be an example of an NR or LTE link between the UE 115-a and the network entity 105-a. The communication link 125 may include a bi-directional link that enables both uplink and downlink communications, for example, via the channels 225. For example, the UE 115-a may transmit uplink messages 245 (e.g., uplink transmissions), such as uplink control signals or uplink data signals, to the network entity 105-a using the first channel 225-a (e.g., of the communication link 125) and the network entity 105-a may transmit downlink messages 250 (e.g., downlink transmissions), such as downlink control signals or downlink data signals, to the UE 115-a using the second channel 225-b (e.g., of the communication link 125). In some examples, the downlink messages 250 may be part of control signaling transmitted from the network entity 105-a.

In some examples, the UE 115-a may transmit, via the first channel 225-a, a first uplink message 245-a to the network entity 105-a that indicates one or more types of measurement gap types for which deactivation or skipping may be allowed when a collision occurs between a measurement gap occasion and a transmission or reception occasion for communicating high priority data (e.g., data having a priority greater than a threshold). The network entity 105-a may transmit, via the second channel 225-b, a first downlink message 250-a to the UE 115-a that indicates a measurement gap configuration. For example, the measurement gap configuration may configure the UE 115-a to deactivate or skip measurement gaps based on the indicated measurement gap types.

The measurement gap types may be dynamic. For example, as conditions change at the UE 115-a, at the serving cell, within the wireless communications system 200, and so forth, the measurement gap types that may be allowed for deactivating may change. In some examples, the UE 115-a may transmit, via the first channel 225-a, a second uplink message 245-b to the network entity 105-a that indicates another set of the measurement gap types for which deactivation or skipping may be allowed. The network entity 105-a may transmit, via the second channel 225-b, a second downlink message 250-b to the UE 115-a that indicates a measurement gap configuration based on the other set of the measurement gap types indicated in the second uplink message 245-b. In some examples, the network entity 105-a may transmit, via the second channel 225-b, a third downlink message 250-c to the UE 115-a that indicates the high priority data during a duration that at least partially overlaps with a measurement gap based on the measured gap being a type that is allowable for deactivation.

FIG. 3 shows an example of a timing diagram 300 that supports measurement gap deactivation in accordance with one or more aspects of the present disclosure. The timing diagram 300 includes measurement types 305, measurement gaps 310, DRX cycle 315, and burst arrivals 320.

The UE 115 may convey which measurement gap types are allowable for deactivating and the network entity 105 may configure the UE 115 accordingly. In the depicted figure, a first measurement gap type 305-a is a multi-(U)SIM measurement gap, which is indicated as allowable for deactivating. Accordingly, the first measurement gap 310-a may be deactivated (as indicated by the dash line) during a first on-duration 315-a, in which the UE 115 may receive all of the data transmitted in a first burst 320-a.

The measurement gaps may each be 20 milliseconds (ms) long while the on-duration of the DRX cycle 315 is 17 ms, or in some examples, 16 ms. The burst arrivals may be 16.72 ms long based on a 60 Hz rate (e.g., 1/60 Hz is 16.67 ms). The second measurement gap type 305-b may be a per-UE measurement gap and a third measurement gap type 305-c may be a network controlled small gap (NCSG), both of which may not be indicated as measurement gap types that are allowable for deactivating.

During a second on-duration 315-b, before the start of a second measurement gap 310-b, the UE 115 may receive a second data burst 320-b. However, the second on-duration 315-b for receiving the second data burst 320-b may overlap with the second measurement gap 310-b and the second measurement gap type 305-b is not to be deactivated. Thus, the UE 115 may not receive data from the second data burst 320-b during the portion of the second on-duration 315-b that overlaps with the second measurement gap 310-b. The remaining portion of the data of the second data burst 320-b that is not received by the UE 115 during the second on-duration 315-b may be communicated to the UE 115 in the next on-duration, such as a third on-duration 315-c.

During the third on-duration 315-c, before the start of the third measurement gap 310-c, the UE 115 may receive the rest of the second data burst 320-b. However, the third on-duration 315-c for receiving the rest of the second data burst 320-b may overlap with the third measurement gap 310-c and the third measurement gap type 305-c is not to be deactivated. Thus, the UE 115 may not receive all of the remaining data from the second data burst 320-b during the portion of the third on-duration 315-c that overlaps with the third measurement gap 310-c. The remaining portion of the data of the second data burst 320-b that is not received by the UE 115 during the second on-duration 315-b and the third on-duration 315-c may be communicated to the UE 115 in the next on-duration, such as a fourth on-duration 315-d.

Since there is no measurement gap 310 during the fourth on-duration 315-d, the UE 115 may receive the rest of the second data burst 320-b, as well as the third data burst 320-c and the fourth data burst 320-d if all of the data can be transmitted during the fourth on-duration 315-d.

In some examples, the various type of measurement gaps may include per-UE and/or per frequency range (FR) measurement gap. The per-UE and/or the per-FR measurement gap may be referred to as a regular measurement gap. The various types of measurement gaps may also include a preconfigured measurement gap, where one or more measurement gaps are preconfigured and sent to the UE 115. The preconfigured measurement gap may be autonomously activated or deactivated by the UE 115, for example, when activation or deactivation conditions are met. The various types of measurement gaps may also include an NCSG and/or an MUSIM. The MUSIM type gap may include a measurement gap used for cell identification and measurement, paging, monitoring, system information block (SIB) (e.g., from the network entity 105) acquisition, and/or an on-demand system information (SI) request of a target cell in the target network. The various types of measurement gaps may also include an uplink gap for transmission power management.

In some examples, the UE 115 may be willing to deactivate some measurement gap types while being not willing to deactivate other measurement gap types. For example, normal or regular measurement gaps (e.g., per-UE and/or per FR measurement gaps) may be deprioritized while MUSIM gaps, which may be used to obtain important information related to a secondary network, may not be deprioritized. In some examples, the pre-configured measurement gap types may not be deprioritized, for example, based on one or more conditions being met.

As discussed herein, a measurement gap may be skipped or deactivated for example, to facilitate the UE 115 receiving high priority data (e.g., time-critical data). The UAI indicated by the UE 115 to the network entity 105 may indicate which type of measurement gaps (e.g., regular measurement gap, preconfigured measurement gap, NCSG, MUSIM, and/or uplink measurement gaps) may be deactivated if they collide with the high priority data, such as the XR data.

A bitmap may be defined to indicate which measurement gap types may be deactivated. For example, a five bit bitmap may correspond to the normal measurement gap, the preconfigured measurement gap, the NCSG, the MUSIM, or the uplink measurement gap. A bitmap of 10101 may correspond to allowing deactivation for normal measurement gaps, NCSG, and uplink measurement gaps, while deactivation may not be allowed for the preconfigured measurement or the MUSIM (indicating that the preconfigured measurement gap and MUSIM may not be deprioritized relative to high priority data).

For measurement gap types that may be deactivated, the UAI may carry additional information, for example on a per-measurement gap type basis. For example, for each measurement gap type that may be deactivated, the UE 115 may indicate particular components. The components may include one or more of the quantity of consecutive measurement gaps or quantity of measurement gaps within a time period that may be deactivated. The components may also include a quantity of measurement gaps within a time period that may be deactivated, measurement gap patterns that may be configured while the measurement gap is deactivated, and/or RSRP thresholds (e.g., for switching serving cell to target cells).

In some examples, the UAI may be transmitted either periodically, based on a network trigger or based on an event trigger. Regarding the periodic UAI transmission, the network entity 105 may configure a periodicity in which the UE 115 may send the UAI. In some examples, the periodic UAI transmission may keep the network updated of UE 115 preferences, for example, regarding the measurement gap types that may be deactivated.

Regarding the network-triggered UAI transmission, the network entity 105 may indicate to the UE 115 to transmit the UAI based on one or more conditions. For example, the network entity 105 may not, in some instances, have time-critical data (e.g., data to transmit or receive). In such examples, the network entity 105 may indicate to the UE 115 to transmit the UAI when the time-critical data (e.g., XR data) is expected. In some examples, once triggered by the network entity 105, the UE 115 may periodically send the UAI for a particular period of time.

Regarding the event-triggered UAI transmission, the UE 115 may transmit the UAI based on some event triggers, such as a bandwidth part (BWP) switch, a carrier BW (CBW) switch, measurement objects (MO) update, mobility event triggers, and so forth. In some examples, the network entity 105 may indicate to the UE 115 to transmit some components of the UAI. The other components may be deduced by the network entity 105 based on other UE reports (e.g., mobility-related components may be deduced based on the measurement reports) or may not be used by the network entity 105 in deactivating the measurement gaps. Additionally, or alternatively, the UE 115 may send the entire UAI or partial UAI including components that have changed since the last UAI transmission.

FIG. 4 shows an example of a process flow 400 that supports measurement gap deactivation in accordance with one or more aspects of the present disclosure. The process flow 400 may implement aspects of or may be implemented by aspects of the wireless communications system 100 or the wireless communications system 200. For example, the process flow 400 may include a UE 115-b and a network entity 105-b, which may be an example of a UE 115 and a network entity 105 as described herein. In the following description of the process flow 400, the operations performed by the UE 115-b and the network entity 105-b may be performed in different orders or at different times than the exemplary order shown. Some operations may also be omitted from the process flow 400, or other operations may be added to the process flow 400. Further, while operations in the process flow 400 are illustrated as being performed by the UE 115-b and the network entity 105-b, the examples herein are not to be construed as limiting, as the described features may be associated with any quantity of different devices.

At 405, the UE 115-b may transmit an indication of one or more types of measurement gaps for which deactivation is supported based on collisions with data having a priority satisfying a threshold. The indication may include a bitmap indicating the one or more types of measurement gaps via bits of the bitmap. A data priority of the data satisfying the threshold may include XR data. The UE 115-b may transmit, periodically, the indication of the one or more types of measurement gaps. The UE 115-b may transmit, based on a trigger event, the indication of the one or more types of measurement gaps.

The one or more types of measurement gaps may include one or more of a UE-specific measurement gap, a FR specific measurement gap, a preconfigured measurement gap, a NCSG, an uplink measurement gap, a MUSIM measurement gap, and a transmit power management measurement gap. In some examples, transmitting the indication may be based on UAI. The UE 115-b may transmit a subset of the UAI for the one or more types of measurement gaps.

At 410, the UE 115-b may receive an indication of deactivation of one or more measurement gaps based on the indication of one or more types of measurement gaps. In some examples, receiving the indication of deactivation includes a DCI signal, a MAC-CE signal, a RRC signal, or any combination thereof

At 415, the UE 115-b may receive the data during a time duration that at least partially overlaps with the one or more measurement gaps based on the indication of deactivation. The UE 115-b may receive the data based at least in part on suppressing the one or more types of measurement gaps.

In some examples, at 420, UE 115-b may transmit a second indication of a second one or more types of measurement gaps associated with a change since the indication of the one or more types of measurement gaps.

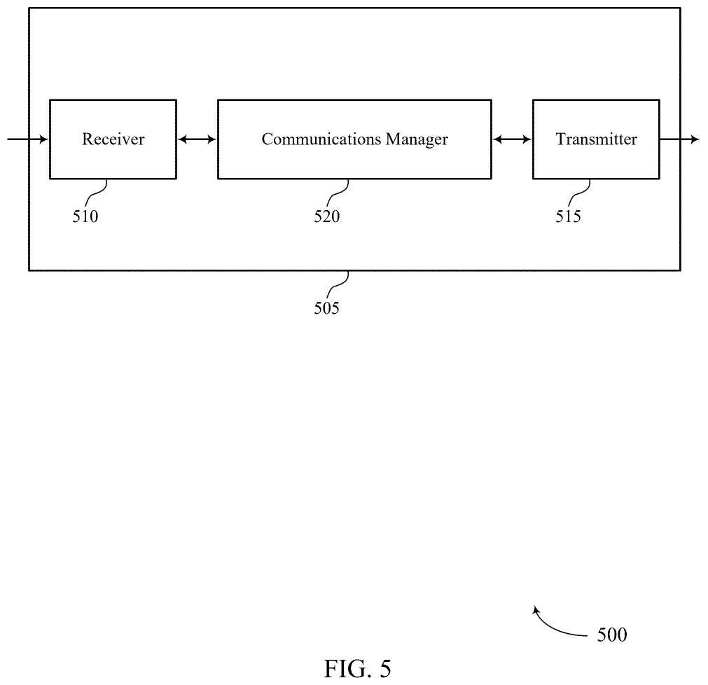

FIG. 5 shows a block diagram 500 of a device 505 that supports measurement gap deactivation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to measurement gap deactivation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to measurement gap deactivation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of measurement gap deactivation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting an indication of one or more types of measurement gaps for which deactivation is supported based on collisions with data having a priority satisfying a threshold. The communications manager 520 is capable of, configured to, or operable to support a means for receiving an indication of deactivation of one or more measurement gaps based on the indication of one or more types of measurement gaps. The communications manager 520 is capable of, configured to, or operable to support a means for receiving the data during a time duration that at least partially overlaps with the one or more measurement gaps based on the indication of deactivation.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reducing collisions of time-critical data during a measurement gap.

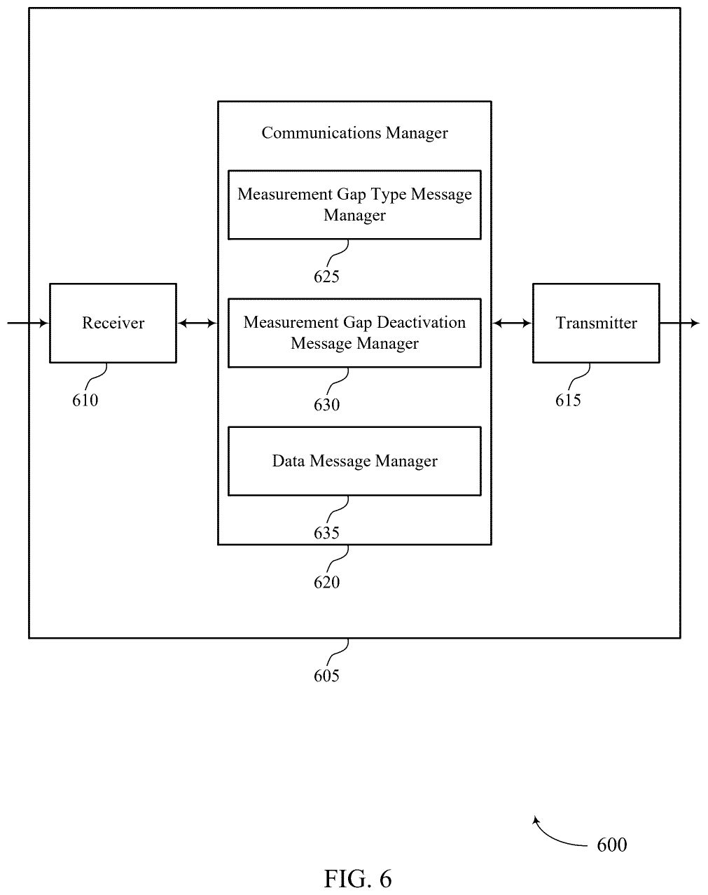

FIG. 6 shows a block diagram 600 of a device 605 that supports measurement gap deactivation in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to measurement gap deactivation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to measurement gap deactivation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of measurement gap deactivation as described herein. For example, the communications manager 620 may include a measurement gap type message manager 625, a measurement gap deactivation message manager 630, a data message manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The measurement gap type message manager 625 is capable of, configured to, or operable to support a means for transmitting an indication of one or more types of measurement gaps for which deactivation is supported based on collisions with data having a priority satisfying a threshold. The measurement gap deactivation message manager 630 is capable of, configured to, or operable to support a means for receiving an indication of deactivation of one or more measurement gaps based on the indication of one or more types of measurement gaps. The data message manager 635 is capable of, configured to, or operable to support a means for receiving the data during a time duration that at least partially overlaps with the one or more measurement gaps based on the indication of deactivation.

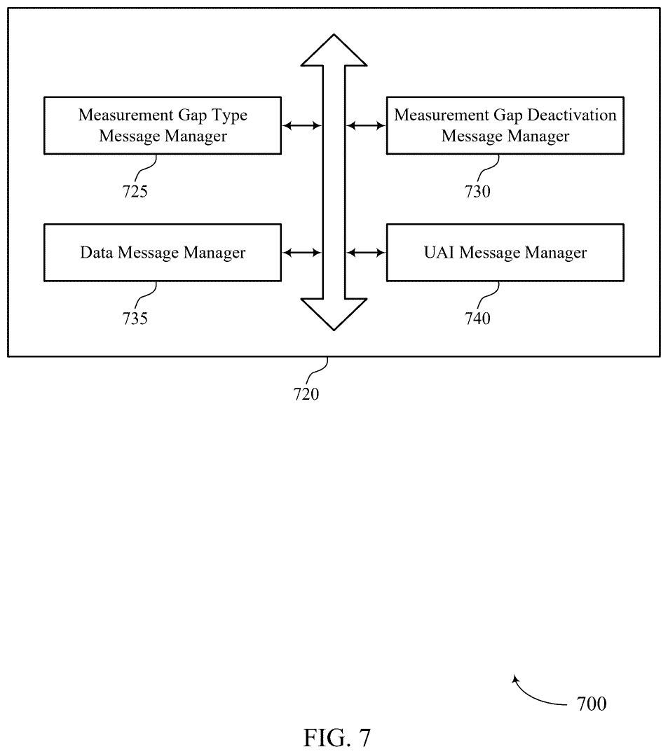

FIG. 7 shows a block diagram 700 of a communications manager 720 that supports measurement gap deactivation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of measurement gap deactivation as described herein. For example, the communications manager 720 may include a measurement gap type message manager 725, a measurement gap deactivation message manager 730, a data message manager 735, a UAI message manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The measurement gap type message manager 725 is capable of, configured to, or operable to support a means for transmitting an indication of one or more types of measurement gaps for which deactivation is supported based on collisions with data having a priority satisfying a threshold. The measurement gap deactivation message manager 730 is capable of, configured to, or operable to support a means for receiving an indication of deactivation of one or more measurement gaps based on the indication of one or more types of measurement gaps. The data message manager 735 is capable of, configured to, or operable to support a means for receiving the data during a time duration that at least partially overlaps with the one or more measurement gaps based on the indication of deactivation.

In some examples, the indication includes a bitmap indicating the one or more types of measurement gaps via bits of the bitmap.

In some examples, the data having the priority satisfying the threshold includes extended reality data.

In some examples, the data message manager 735 is capable of, configured to, or operable to support a means for receiving the data based on suppressing the one or more types of measurement gaps.

In some examples, the one or more types of measurement gaps include one or more of a UE-specific measurement gap, a frequency range specific measurement gap, a preconfigured measurement gap, a network controlled small gap, an uplink measurement gap, a multi-(U)SIM measurement gap, and a transmit power management measurement gap.

In some examples, to support transmitting the indication, the measurement gap type message manager 725 is capable of, configured to, or operable to support a means for transmitting, periodically, the indication of the one or more types of measurement gaps.

In some examples, to support transmitting the indication, the measurement gap type message manager 725 is capable of, configured to, or operable to support a means for transmitting, based on a trigger event, the indication of the one or more types of measurement gaps.

In some examples, transmitting the indication is based on UE assistance information.

In some examples, to support transmitting, the UAI message manager 740 is capable of, configured to, or operable to support a means for transmitting a subset of the UE assistance information for the one or more types of measurement gaps.

In some examples, the measurement gap type message manager 725 is capable of, configured to, or operable to support a means for transmitting a second indication of a second one or more types of measurement gaps associated with a change since the indication of the one or more types of measurement gaps.

In some examples, receiving the indication of deactivation includes a downlink control information signal, a medium access control element signal, a radio resource control signal, or any combination thereof.

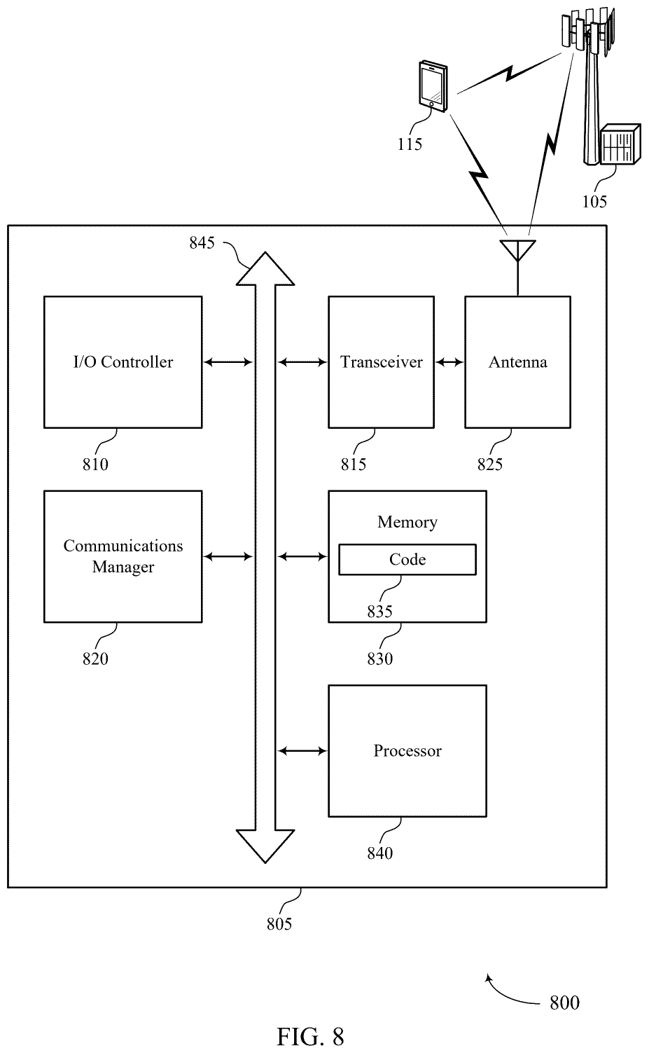

FIG. 8 shows a diagram of a system 800 including a device 805 that supports measurement gap deactivation in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting measurement gap deactivation). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting an indication of one or more types of measurement gaps for which deactivation is supported based on collisions with data having a priority satisfying a threshold. The communications manager 820 is capable of, configured to, or operable to support a means for receiving an indication of deactivation of one or more measurement gaps based on the indication of one or more types of measurement gaps. The communications manager 820 is capable of, configured to, or operable to support a means for receiving the data during a duration that at least partially overlaps with the one or more measurement gaps based on the indication of deactivation.

By including or configuring the communications manager 820 in accordance with examples as described herein, the device 805 may support techniques for reducing collisions between time-critical data and a measurement gap.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of measurement gap deactivation as described herein, or the at least one processor 840 and the at least one memory 830 may be otherwise configured to, individually or collectively, perform or support such operations.

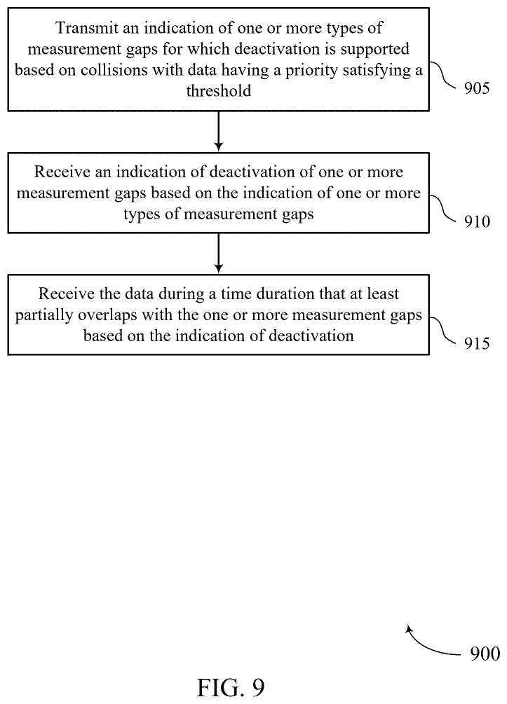

FIG. 9 shows a flowchart illustrating a method 900 that supports measurement gap deactivation in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting an indication of one or more types of measurement gaps for which deactivation is supported based on collisions with data having a priority satisfying a threshold. The operations of 905 may be performed in accordance with examples as disclosed herein. In some examples, aspects of the operations of 905 may be performed by a measurement gap type message manager 725 as described with reference to FIG. 7.

At 910, the method may include receiving an indication of deactivation of one or more measurement gaps based on the indication of one or more types of measurement gaps. The operations of 910 may be performed in accordance with examples as disclosed herein. In some examples, aspects of the operations of 910 may be performed by a measurement gap deactivation message manager 730 as described with reference to FIG. 7.

At 915, the method may include receiving the data during a duration that at least partially overlaps with the one or more measurement gaps based on the indication of deactivation. The operations of 915 may be performed in accordance with examples as disclosed herein. In some examples, aspects of the operations of 915 may be performed by a data message manager 735 as described with reference to FIG. 7.

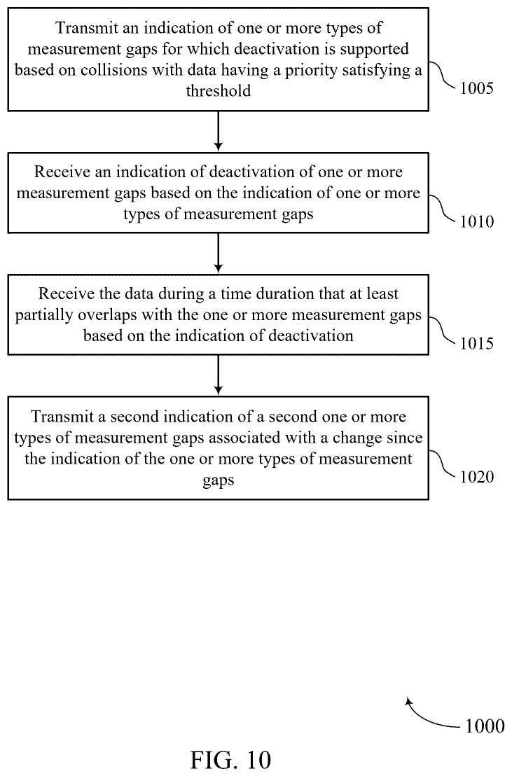

FIG. 10 shows a flowchart illustrating a method 1000 that supports measurement gap deactivation in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting an indication of one or more types of measurement gaps for which deactivation is supported based on collisions with data having a priority satisfying a threshold. The operations of 1005 may be performed in accordance with examples as disclosed herein. In some examples, aspects of the operations of 1005 may be performed by a measurement gap type message manager 725 as described with reference to FIG. 7.

At 1010, the method may include receiving an indication of deactivation of one or more measurement gaps based on the indication of one or more types of measurement gaps. The operations of 1010 may be performed in accordance with examples as disclosed herein. In some examples, aspects of the operations of 1010 may be performed by a measurement gap deactivation message manager 730 as described with reference to FIG. 7.

At 1015, the method may include receiving the data during a time duration that at least partially overlaps with the one or more measurement gaps based on the indication of deactivation. The operations of 1015 may be performed in accordance with examples as disclosed herein. In some examples, aspects of the operations of 1015 may be performed by a data message manager 735 as described with reference to FIG. 7.

At 1020, the method may include transmitting a second indication of a second one or more types of measurement gaps associated with a change since the indication of the one or more types of measurement gaps. The operations of 1020 may be performed in accordance with examples as disclosed herein. In some examples, aspects of the operations of 1020 may be performed by a measurement gap type message manager 725 as described with reference to FIG. 7. The following provides an overview of aspects of the present disclosure:
Aspect 1: A method for wireless communications at a UE, comprising: transmitting an indication of one or more types of measurement gaps for which deactivation is supported based on collisions with data having a priority satisfying a threshold; receiving an indication of deactivation of one or more measurement gaps based at least in part on the indication of one or more types of measurement gaps; and receiving the data during a time duration that at least partially overlaps with the one or more measurement gaps based at least in part on the indication of deactivation.
Aspect 2: The method of aspect 1, wherein the indication comprises a bitmap indicating the one or more types of measurement gaps via bits of the bitmap.
Aspect 3: The method of any of aspects 1 through 2, wherein the data having the priority satisfying the threshold comprises extended reality data.
Aspect 4: The method of any of aspects 1 through 3, wherein receiving the data further comprising: receiving the data based at least in part on suppressing the one or more types of measurement gaps.
Aspect 5: The method of any of aspects 1 through 4, wherein the one or more types of measurement gaps comprise one or more of a UE-specific measurement gap, a frequency range specific measurement gap, a preconfigured measurement gap, a NCSG, an uplink measurement gap, a MUSIM measurement gap, and a transmit power management measurement gap.
Aspect 6: The method of any of aspects 1 through 5, wherein transmitting the indication further comprises: transmitting, periodically, the indication of the one or more types of measurement gaps.
Aspect 7: The method of any of aspects 1 through 6, wherein transmitting the indication further comprises: transmitting, based at least in part on a trigger event, the indication of the one or more types of measurement gaps.
Aspect 8: The method of any of aspects 1 through 7, wherein transmitting the indication is based at least in part on UAI.
Aspect 9: The method of aspect 8, wherein transmitting further comprises: transmitting a subset of the UAI for the one or more types of measurement gaps.
Aspect 10: The method of any of aspects 1 through 9, further comprising: transmitting a second indication of a second one or more types of measurement gaps associated with a change since the indication of the one or more types of measurement gaps.
Aspect 11: The method of any of aspects 1 through 10, wherein receiving the indication of deactivation comprises a downlink control information signal, a medium access control element signal, a radio resource control signal, or any combination thereof.
Aspect 12: A UE for wireless communications, comprising one or more memories storing processor-executable code, and one or more processors coupled with the one or more memories and individually or collectively operable to execute the code to cause the UE to perform a method of any of aspects 1 through 11.
Aspect 13: A UE for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit an indication of one or more types of measurement gaps for which deactivation is supported based on collisions with data having a priority satisfying a threshold;
receive an indication of deactivation of one or more measurement gaps based at least in part on the indication of one or more types of measurement gaps; and
receive the data during a time duration that at least partially overlaps with the one or more measurement gaps based at least in part on the indication of deactivation.

2. The UE of claim 1, wherein the indication comprises a bitmap indicating the one or more types of measurement gaps via bits of the bitmap.

3. The UE of claim 1, wherein the data having the priority satisfying the threshold comprises extended reality data.

4. The UE of claim 1, wherein the one or more processors are individually or collectively further operable to execute the code to cause the UE to:
receive the data based at least in part on suppressing the one or more types of measurement gaps.

5. The UE of claim 1, wherein the one or more types of measurement gaps comprise one or more of a UE-specific measurement gap, a frequency range specific measurement gap, a preconfigured measurement gap, a network controlled small gap, an uplink measurement gap, a multi-(U)SIM measurement gap, and a transmit power management measurement gap.

6. The UE of claim 1, wherein, to transmit the indication, the one or more processors are individually or collectively further operable to execute the code to cause the UE to:
transmit, periodically, the indication of the one or more types of measurement gaps.

7. The UE of claim 1, wherein, to transmit the indication, the one or more processors are individually or collectively further operable to execute the code to cause the UE to:
transmit, based at least in part on a trigger event, the indication of the one or more types of measurement gaps.

8. The UE of claim 1, wherein transmitting the indication is based at least in part on UE assistance information.

9. The UE of claim 8, wherein, to transmit, the one or more processors are individually or collectively further operable to execute the code to cause the UE to:
transmit a subset of the UE assistance information for the one or more types of measurement gaps.

10. The UE of claim 1, wherein the one or more processors are individually or collectively further operable to execute the code to cause the UE to:
transmit a second indication of a second one or more types of measurement gaps associated with a change since the indication of the one or more types of measurement gaps.

11. The UE of claim 1, wherein receiving the indication of deactivation comprises a downlink control information signal, a medium access control element signal, a radio resource control signal, or any combination thereof.

12. A method for wireless communications at a user equipment (UE), comprising:
transmitting an indication of one or more types of measurement gaps for which deactivation is supported based on collisions with data having a priority satisfying a threshold;
receiving an indication of deactivation of one or more measurement gaps based at least in part on the indication of one or more types of measurement gaps; and
receiving the data during a time duration that at least partially overlaps with the one or more measurement gaps based at least in part on the indication of deactivation.

13. The method of claim 12, wherein the indication comprises a bitmap indicating the one or more types of measurement gaps via bits of the bitmap.

14. The method of claim 12, wherein the data having the priority satisfying the threshold comprises extended reality data.

15. The method of claim 12, wherein receiving the data further comprising:
receiving the data based at least in part on suppressing the one or more types of measurement gaps.

16. The method of claim 12, wherein the one or more types of measurement gaps comprise one or more of a UE-specific measurement gap, a frequency range specific measurement gap, a preconfigured measurement gap, a network controlled small gap, an uplink measurement gap, a multi-(U)SIM measurement gap, and a transmit power management measurement gap.

17. The method of claim 12, wherein transmitting the indication further comprises:
transmitting, periodically, the indication of the one or more types of measurement gaps.

18. A non-transitory computer-readable medium storing code for wireless communications, the code comprising instructions executable by one or more processors to:
transmit an indication of one or more types of measurement gaps for which deactivation is supported based on collisions with data having a priority satisfying a threshold;
receive an indication of deactivation of one or more measurement gaps based at least in part on the indication of one or more types of measurement gaps; and
receive the data during a time duration that at least partially overlaps with the one or more measurement gaps based at least in part on the indication of deactivation.

19. The non-transitory computer-readable medium of claim 18, wherein the instructions are further executable by the one or more processors to:
transmit a second indication of a second one or more types of measurement gaps associated with a change since the indication of the one or more types of measurement gaps.

20. The non-transitory computer-readable medium of claim 18, wherein receiving the indication of deactivation comprises a downlink control information signal, a medium access control element signal, a radio resource control signal, or any combination thereof.
